(19) United States
(12) Patent Application Publication
(10) Pub. No.: US 2016/0266339 A1
(43) Pub. Date: Sep. 15, 2016

(54) CABLE CONNECTOR RETENTION DESIGN

(71) Applicant: FINISAR CORPORATION, SUNNYVALE, CA (US)

(72) Inventors: RANRAN ZHANG, Sunnyvale, CA (US); SHAMEI SHI, Sunnyvale, CA (US); WILLIAM H. WANG, Sunnyvale, CA (US)

(21) Appl. No.: 14/643,928

(22) Filed: Mar. 10, 2015

(51) Int. Cl. G02B 6/42; G02B 6/38; G02B 6/32

(52) U.S. Cl. CPC G02B 6/4292; G02B 6/4206; G02B 6/32; G02B 6/3885; G02B 6/3893

(57) ABSTRACT

An example embodiment includes a pluggable active optical cable connector configured to permanently maintain engagement of an optical interface included in an optoelectronic module. The pluggable active optic cable connector includes a lens connection section which connects a plurality of optical fibers to the optical interface, a latching portion which engages with a latch receiving portion of the optoelectronic module, the latching portion including a first engagement portion which engages with an optoelectronic engagement portion of the optical interface and a second engagement portion, and a locking portion which engages with the second engagement portion of the latching portion and locks the lens connection section in place with respect to the optoelectronic module as a plug insertion force is applied to the pluggable active optical cable connector so as to prevent the lens connection section from disengaging from the optical interface of the optoelectronic module.

### CROSS-REFERENCE TO RELATED APPLICATIONS

None.

### FIELD

Embodiments disclosed herein relate to optical components. In particular, some embodiments described herein relate to cable connectors that may be used with optoelectronic modules and a means for connecting and attaching cable connectors to optical modules.

### BACKGROUND

Fiber-optic transmission media are increasingly used for transmitting optical, voice, and data signals. As a transmission vehicle, light provides a number of advantages over traditional electrical communication techniques. For example, optical signals enable extremely high transmission rates and very high bandwidth capabilities. Also, optical signals are unaffected by electromagnetic radiation that causes electromagnetic interference (“EMI”) in electrical signals. Optical signals also provide a more secure signal because the optical transmission medium, such as an optical fiber, does not allow portions of the signal to escape, or be tapped, from the optical fiber, as can occur with electrical signals in wire-based transmission systems. Optical signals can also be transmitted over relatively greater distances without experiencing the signal loss typically associated with transmission of electrical signals over such distances.

While optical communications provide a number of advantages, the use of light as a data transmission vehicle presents a number of implementation challenges. For example, prior to being received and/or processed, the data represented by the optical signal must be converted to an electrical form. Similarly, the data signal must be converted from an electronic form to an optical form prior to transmission onto the optical network.

These conversion processes may be implemented by optical transceiver modules located at either end of an optical fiber. A typical optical transceiver module contains a laser transmitter circuit capable of converting electrical signals to optical signals, and an optical receiver capable of converting received optical signals into electrical signals. The optical transceiver module may be electrically interfaced with a host device, such as a host computer, switching hub, network router, switch box, or computer I/O, via a compatible connection port.

One example of a connection port and compatible connector that is currently used in the art is a plug-and-play multi-fiber push-on (MPO) receptacle, which enables a multi-fiber cable, such as a 4-fiber, 12-fiber, or 24-fiber cable including Quad (4-channel) Small Form-factor Pluggable (QSFP), CXP, CDFP, CFP2, and CFP4 active optical cable, to connect to the optical network and accelerate bandwidth and traffic speeds. Currently, such systems are used to support multiple-dwelling unit (MDU) applications and core network applications, including central offices, switching centers, data centers, radio network controllers, base station controllers and cell sites.

One difficulty with the existing active optical cable products is that while they have generally been designed to be easily plugged in and out of the corresponding receptacle, it is difficult to permanently attach and connect the cables to the transceiver modules. Without the ability to permanently attach and connect the cables, it is difficult to provide products where the transceiver module and active optical cable products are sold as an assembled or coupled unit without increasing the manufacturing process or greatly increasing inventory on the existing modules and cables.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

An example embodiment includes a pluggable active optic cable connector configured to permanently maintain engagement of an optical interface included in an optoelectronic module. The pluggable active optic cable connector includes a lens connection section which connects a plurality of optic fibers to the optical interface, a latching portion which engages with a latch receiving portion of the optical interface. The latching portion causes the optic fibers of the lens connection section to maintain engagement with the lens assembly of the optical interface and includes a first engagement portion which engages with an optoelectronic engagement portion of the optical interface and a second engagement portion. The integrated cable and optoelectronic module also includes a locking portion which engages with the second engagement portion of the latching portion and locks the lens connection section in place with respect to the optical interface as a plug insertion force is applied to the pluggable active optic cable connector so as to prevent the lens connection section from disengaging from the optical interface.

Another example embodiment includes an integrated active optic cable and optoelectronic module. The integrated cable and optoelectronic module includes an optical interface which interfaces with a port of a host device, a lens connection section which connects a plurality of optic fibers to the optical interface, a latching portion which engages with a latch receiving portion of the optical interface. The latching portion causes the optic fibers of the lens connection section to maintain engagement with the lens assembly of the optical interface and includes a first engagement portion which engages with an optoelectronic engagement portion of the optical interface and a second engagement portion. The integrated cable and optoelectronic module also includes a locking portion which engages with the second engagement portion of the latching portion and locks the lens connection section in place with respect to the optical interface as a plug insertion force is applied to the pluggable active optic cable connector so as to prevent the lens connection section from disengaging from the optical interface.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is an isometric view of an example of the cable retention design as an example of a first embodiment;

FIG. 2 is an exploded isometric view of the cable retention design of the first embodiment shown in FIG. 1;

FIGS. 3A-3B are isometric cross-sectional views of the example optoelectronic module and a cable including the pluggable connector which illustrate the locking mechanism and cable retention design of the first embodiment shown in FIG. 1;

FIGS. 4A-4D are cross-sectional views of the example optoelectronic module and a cable including the pluggable connector which illustrate the locking mechanism and cable retention design of the first embodiment shown in FIG. 1;

FIGS. 5A-5B are isometric views of an active optical cable product currently known in the art.

### DESCRIPTION OF SOME EXAMPLE EMBODIMENTS

Particular embodiments of the present disclosure will be described with reference to the accompanying drawings. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of configurations, all of which are explicitly contemplated herein.

Embodiments disclosed herein relate to optical components. More particularly, some example embodiments relate to a cable connector for an optoelectronic module, cable locking mechanism, and cable retention design which provide a simpler and more reliable way to permanently connect and attach cables to optoelectronic modules. The embodiments described herein provide various benefits including the ability to simplify manufacturing processes, reduce inventory on modules and cables, and permanently and securely connect cables to optoelectronic modules. Further, embodiments herein are capable of being applied to existing active optical cable products without requiring a complicated redesign of the current products.

An example embodiment includes a cable connector that may be plugged into an optoelectronic module permanently so as to maintain engagement of the multi-fiber cable to an optical engine. In instances where the cable connector is used on both ends of a multi-lane fiber optical cable, an active optical product may be provided that has a transceiver module permanently attached to each end of the optical cable. Embodiments herein differ from products currently used in the art which can be unplugged once they are plugged into a transceiver module or optoelectronic module.

Although the embodiments are described in the context of optical transceiver modules and active optic cables used in the field of optical networking, it will be appreciated that embodiments of the invention may be employed in other fields and/or operating environments where the functionality disclosed herein may be useful. Accordingly, the scope of the invention should not be construed to be limited to the exemplary implementations and operating environments disclosed herein.

Embodiments of the present disclosure will now be explained with reference to the accompanying figures.

I. Exemplary Aspects of Existing Active Optical Cables

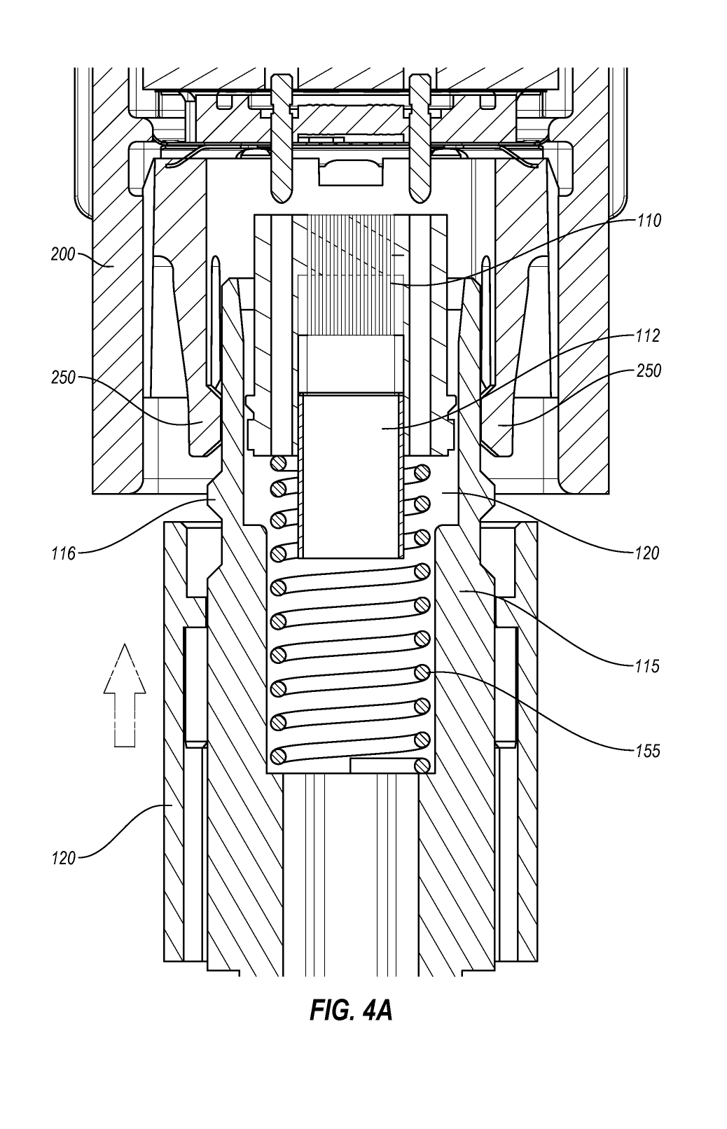

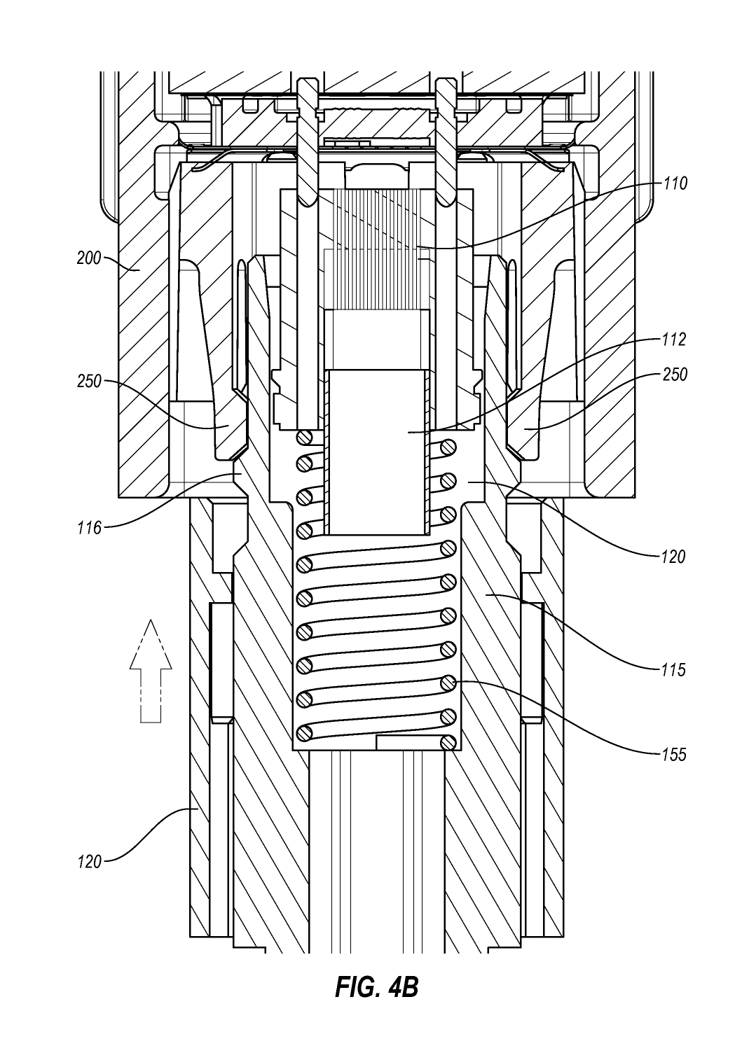

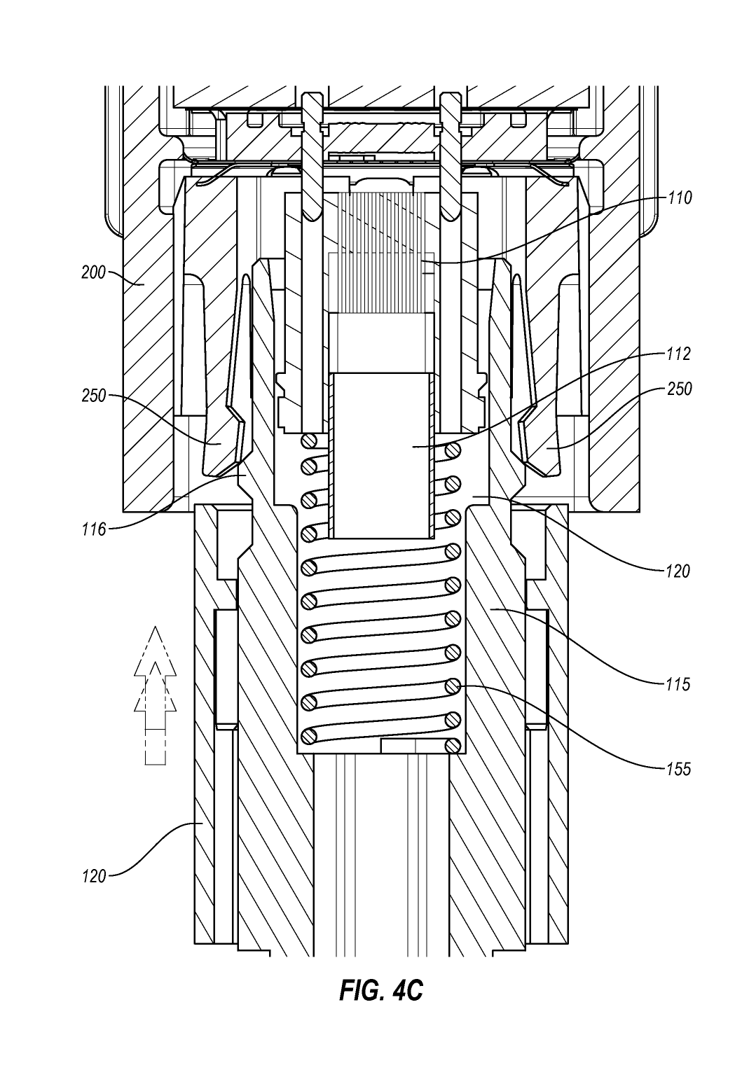

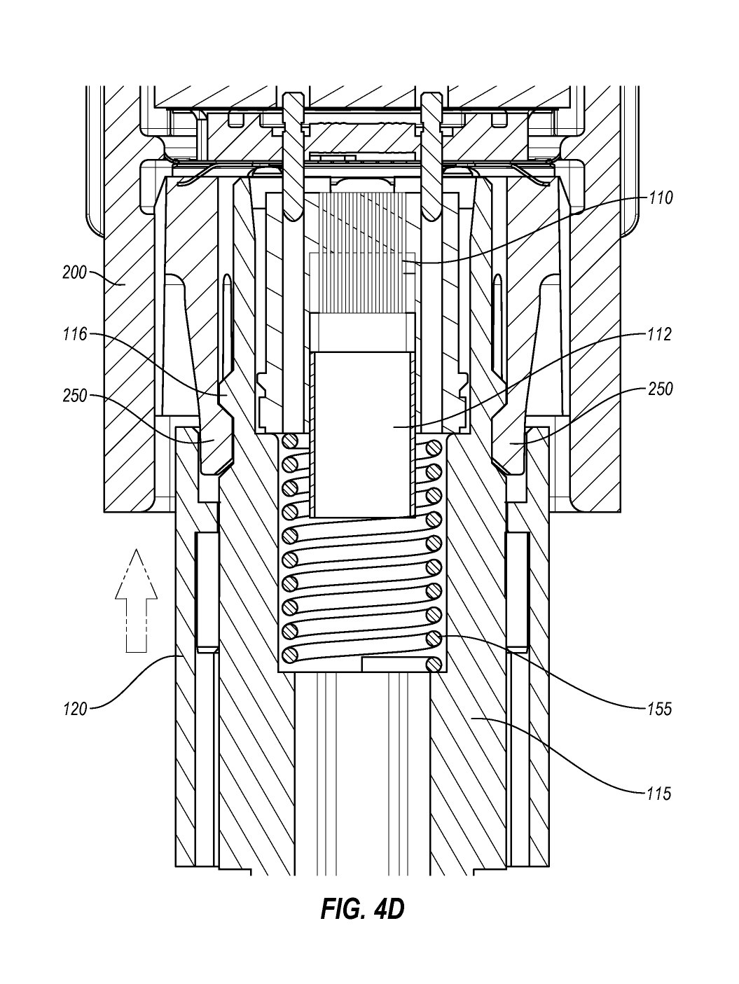

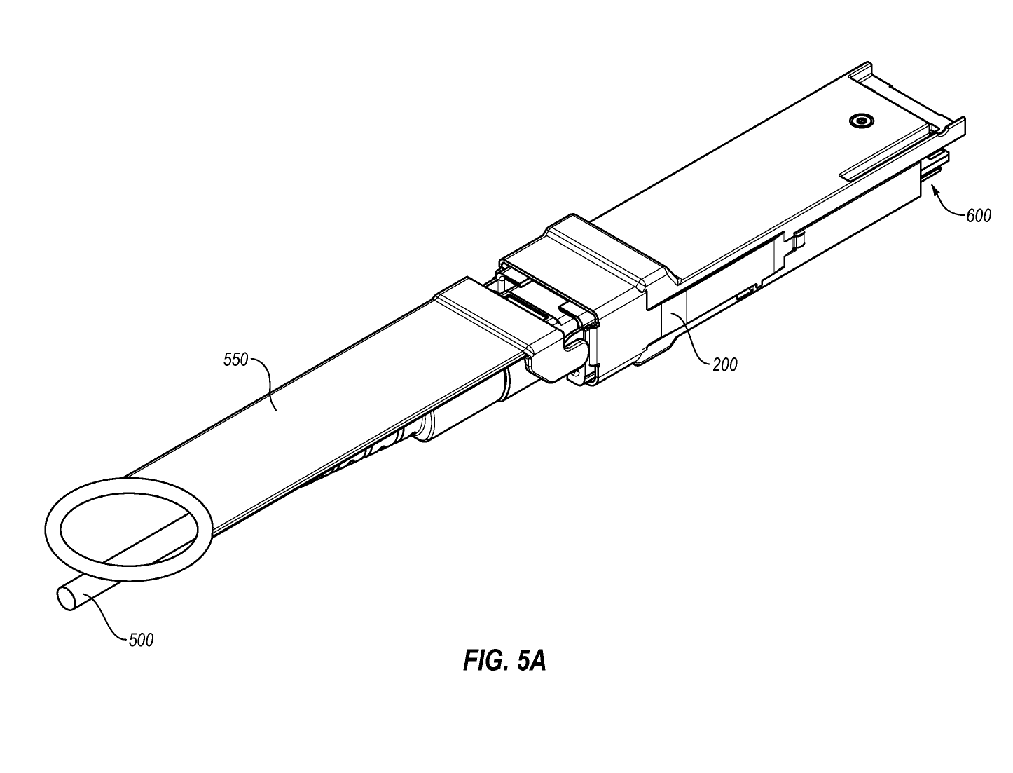

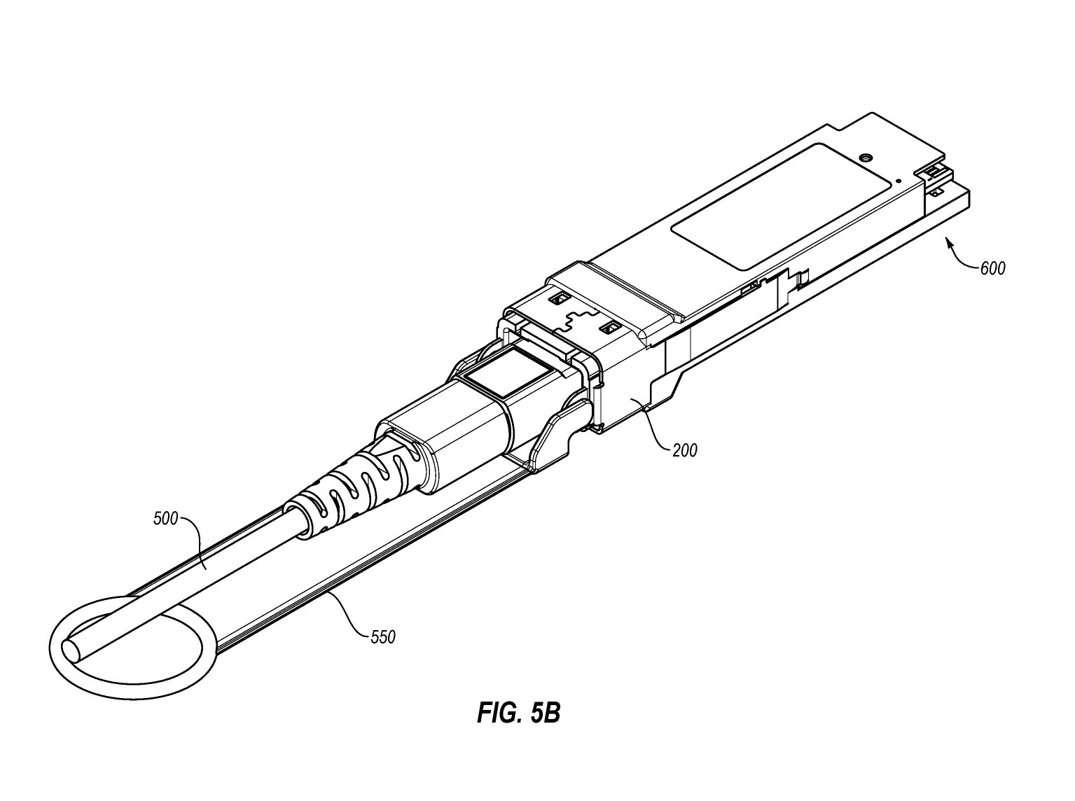

FIGS. 5A-5B are isometric views of existing QSFP active optical cable 500 connected to a QSFP transceiver module, which is an example of an optoelectronic module 200. In this example, the optoelectronic module 200 is hot-pluggable, or is designed to be plugged into a larger electronic system such as a host printed circuit board (PCB) of a network switch or the like. One difficulty with this system, however, is that the handle or bailing mechanism 550 of the optoelectronic module 200 which enables the optoelectronic module 200 to be removed from the larger electronic system may interfere with the active optical cable 500, potentially causing the active optical cable 500 to be disconnected or improperly connected to the optoelectronic module 200. In order to alleviate this problem, the embodiments shown in FIGS. 4A-4D provide a means for permanently connecting an active optical cable to the optoelectronic module 200.

II. Exemplary Structural Aspects of Existing Active Optical Cables

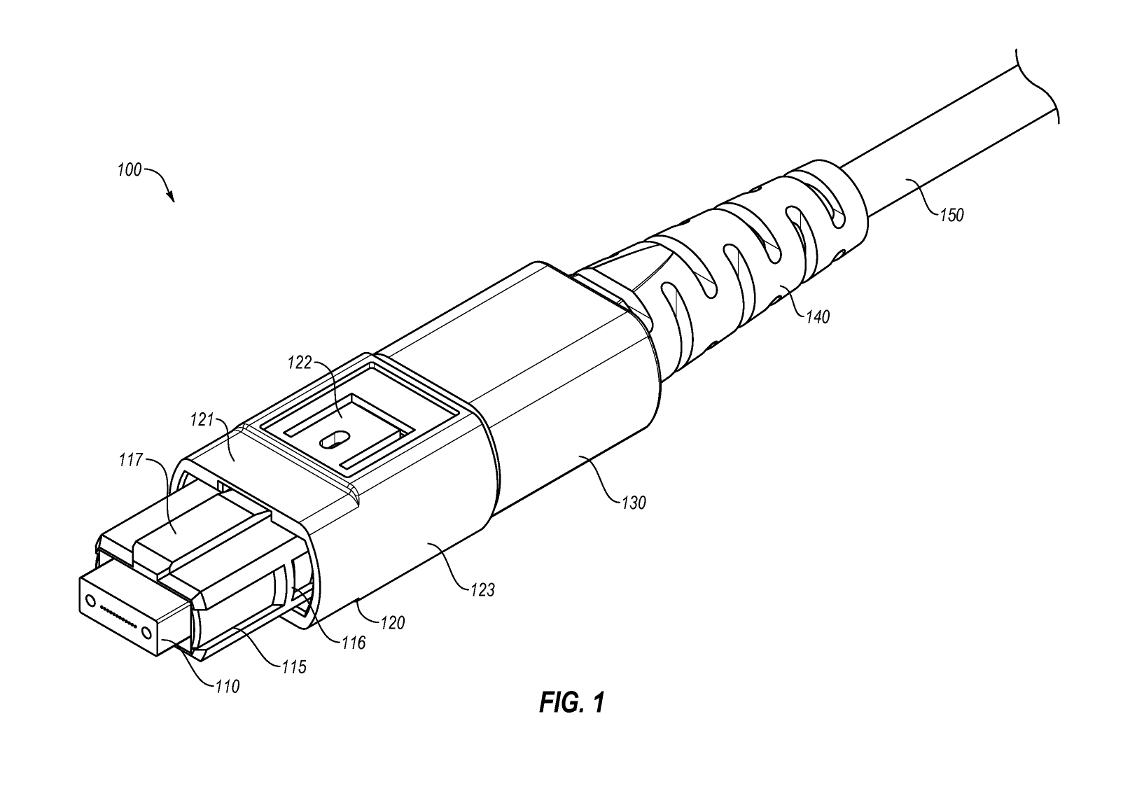

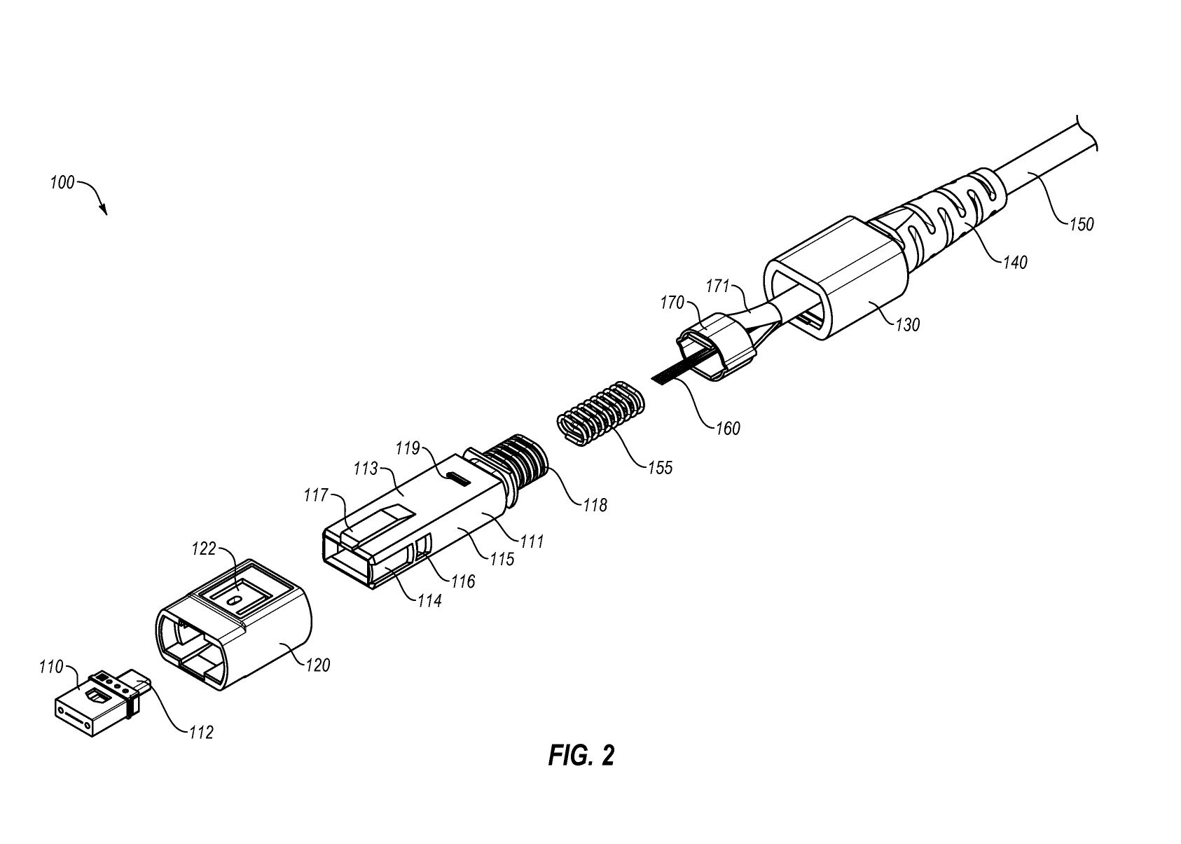

Reference is first made to FIGS. 1 and 2, which illustrate an example of an active optical cable 100 according to one embodiment. Specifically, FIG. 1 is an isometric view of the active optical cable 100 which may be permanently connected to the optoelectronic module 200. FIG. 2 is an exploded isometric view of the active optical cable 100 of FIG. 1.

The optoelectronic module 200 depicted in FIGS. 5A and 5B includes an optical transmitter and an optical receiver. An example of the optoelectronic module 200 may be designed for high-speed (e.g., 25 gigabits per second (G) or higher) optical interconnects between integrated circuits and/or between circuit boards. Additionally or alternatively, the optoelectronic module 200 may be configured to receive four, twelve, twenty-four, or other quantities of optical channels, each of which may be configured to communicate data.

Once mounted to a host PCB (not shown), the optoelectronic module 200 may be configured to communicate data between the host device and a network (not shown), for example. The optoelectronic module 200 may convert electrical signals to optical signals representing the electrical signals and vice versa. For example, data in the form of optical signals may be communicated from a network along the active optical cable 100 to the optoelectronic module 200. Components (examples of which are described below) of the optoelectronic module 200 may convert the optical signals to electrical signals representative of the optical signals. The electrical signals may then be communicated to the host device. Likewise, the host device may communicate electrical signals to the optoelectronic module 200. The optoelectronic module 200 may convert the electrical signals to optical signals representative of the electrical signals. The optical signals may be communicated along the active optical cables 100 into the network to, e.g., another optoelectronic module 200.

The active optical cable 100 includes an MT ferrule 110 and a ferrule boot 112. The ferrule boot 112 connects to a plurality of optical ribbon fibers 160 which extend through the active optical cable 100. The ferrule boot 112 portion of the MT ferrule 110 is housed in the crimp ring base 115. A sleeve 120 extends over the crimp ring base 115. The crimp ring base 115 houses a spring 155 which is configured to encircle the optical ribbon fibers 160. A crimp ring 170 is configured to apply a compressive force to a crimping portion 118 of the crimp ring base 115. The crimp ring 170 also includes a cable jacket portion 171. A cable boot 130 is configured to enclose the crimp ring 170 and cable jacket 171 and the optical ribbon fiber 160 disclosed therein. A terminal end of the cable boot 130 comprises a transition portion 140 which is connected to a protective tube 150 which encloses the optical ribbon fibers 160.

As may be understood by one skilled in the art, the optical ribbon fibers 160 may be individually coated with plastic layers within the protective tube 150 and within the various other components of the active optical cable 100 including the MT ferrule 110, sleeve 120, crimp ring base 115, crimp ring 170, cable jacket 171, and cable boot 130. Further, the plastic layers and the protective tube 150 are made of materials which are suitable for the environment where the active optical cable 100 will be deployed and the embodiments described herein are not limited to any particular materials.

Attention will now be turned to the structural components of the sleeve 120 and crimp ring base 115 which provide the means for permanently locking or fixing the active optical cable 100 to the optoelectronic module 200. The crimp ring base 115 includes a tab portion 117 in a top surface thereof which facilitates connection with the optoelectronic module 200. More specifically, the tab portion 117 is configured to be received by a correspondingly shaped receiving portion (not shown) of the optoelectronic module 200. The tab portion 117 forms a raised plane with two inclined portions formed at the terminal and distal ends thereof. As may be understood by one of skill in the art, the inclined portions facilitate in the removal and insertion of the tab portion 117 and crimp ring base 115 into the receiving portion of the optoelectronic module 200.

Both side surfaces 111 of the crimp ring base 115 have a planar recessed portion 114 formed therein. The planar recessed portions 114 each have an optoelectronic locking tab 116 formed therein such that the surface of the optoelectronic locking tab 116 of this example is configured so as to be coplanar or substantially coplanar with the side surfaces 111 of the crimp ring base. Hence, the optoelectronic locking tab 116 may be viewed as a partition between two separate components of the planar recessed portions 114 formed in each side surface 111 of the crimp ring base 115. As will be described more fully below, the optoelectronic locking tab 116 provides the means for securely locking the active optical cable 100 to the optoelectronic module 200.

The crimp ring base 115 also includes a sleeve locking portion 119 formed in an upper surface 113 thereof which is used as described below to lock the sleeve 120 to the crimp ring base 115. More specifically and is described more fully below, the sleeve locking portion 119 provides a mechanism for simultaneously locking the sleeve 120 to the crimp ring base 115 and the crimp ring base 115 to a corresponding mechanism of the optoelectronic module 200 in order to permanently connect the entire active optical cable 100 to the optoelectronic module 200.

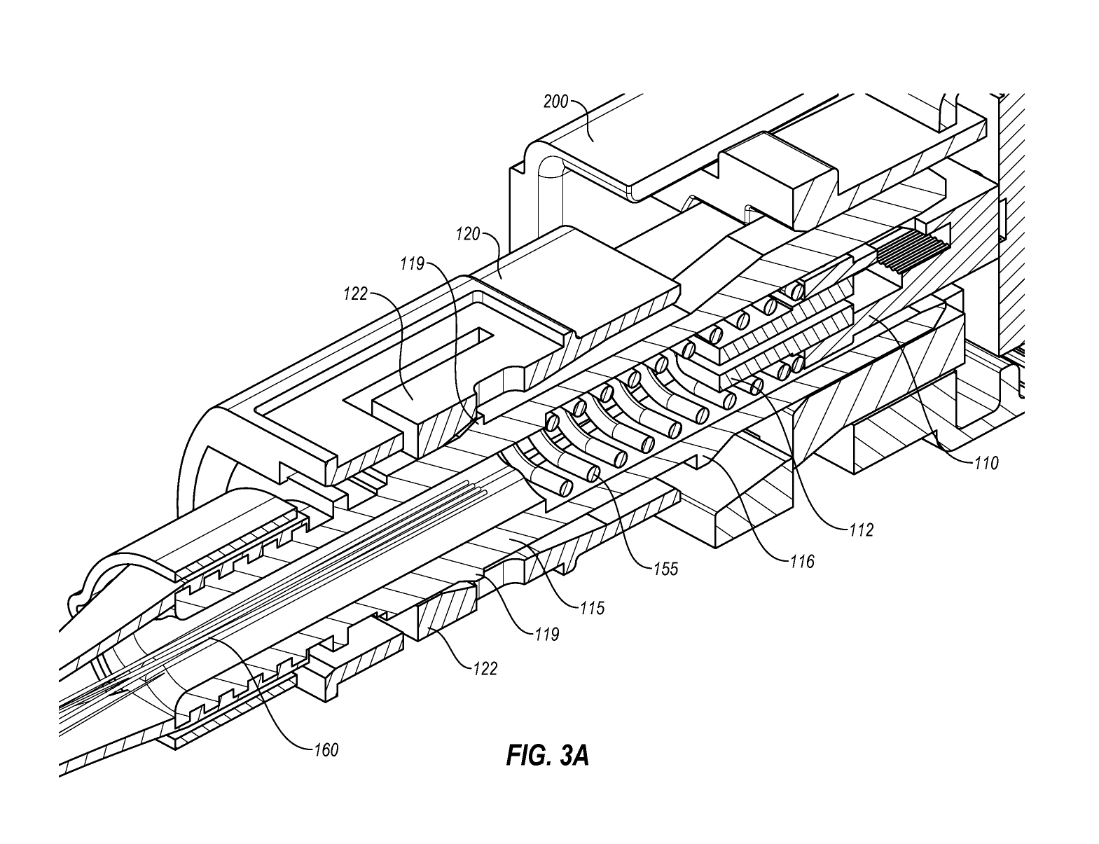

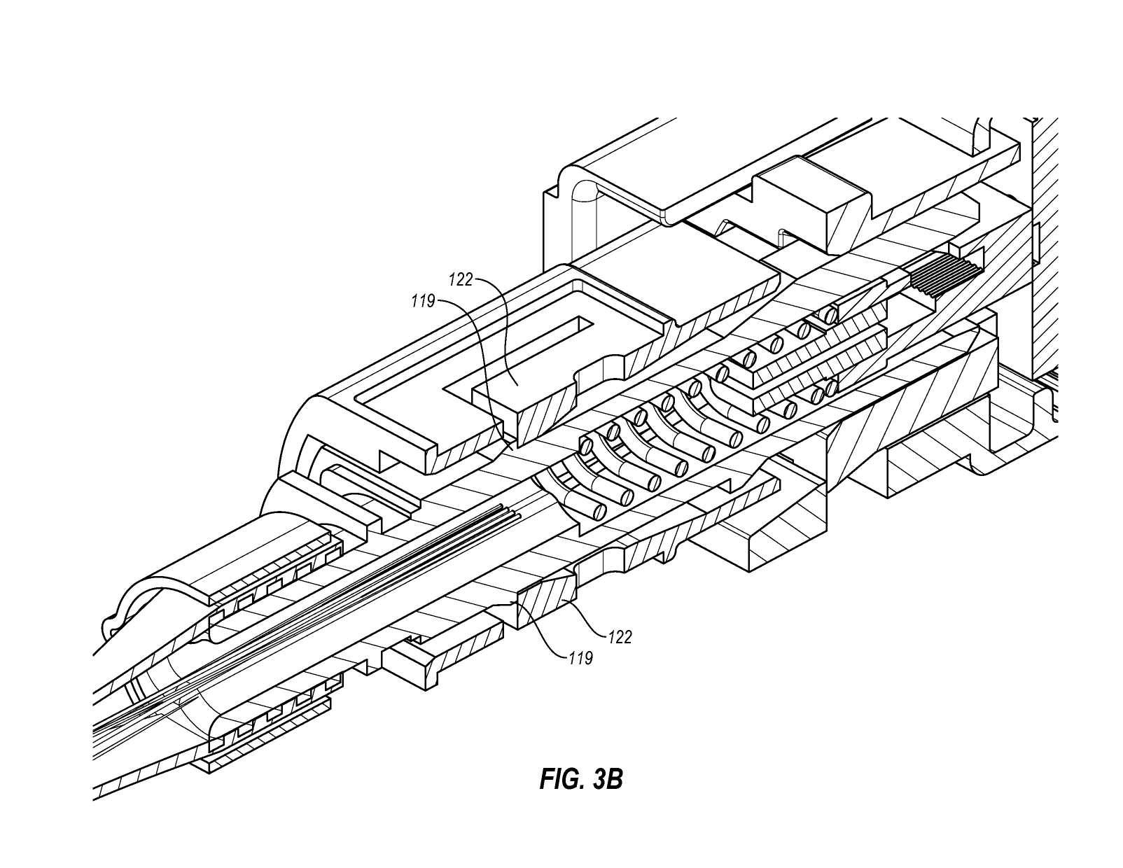

In this example, the sleeve locking portion 119 comprises an angled tooth or projection formed in the upper surface 113 of the crimp ring base 115. The angled tooth configuration of the sleeve locking portion 119 includes an inclined portion which forms an angled surface which gradually extends above the upper surface 113 of the crimp ring base 115 to a flat upper surface and an engaging wall which connects the flat upper surface of the sleeve locking portion 119 to the upper surface 113 of the crimp ring base 115 at a substantially 90 degree angle. As may be understood by one of skill in the art, this shape facilitates in the sliding motion of the sleeve 120 with respect to the crimp ring base 115 in the positive y-direction shown in FIG. 2. At the same time, the 90 degree angle of the engaging wall without a corresponding inclined portion prevents movement in the negative y-direction once the engaging portion 122 of the sleeve 120 is engaged thereon, as is described more fully below. Furthermore, another sleeve locking portion 119 may be formed on the bottom surface as is shown in FIGS. 3A-3B.

Attention will now be turned to describing the sleeve 120. The sleeve 120 comprises a substantially flat sided oval tube, with a flat upper and lower surface 121 and curved side surfaces 123. As was previously described, the inner circumference of the sleeve 120 is formed so as to house the crimp ring base 115 with the spring 155, MT ferrule 110 and optical ribbon fibers 160 housed therein. As is seen in FIG. 1, a portion of the crimp ring base 115 extends beyond a proximal portion of the sleeve 120 so as to be received and enclosed in a corresponding receiving port of the optoelectronic module 200.

A flat upper surface 121 of the sleeve includes an engaging portion 122 which comprises a resilient tab that extends parallel to the flat upper surface 121 of the sleeve 120 and is configured to interact with the sleeve locking portion 119 of the crimp ring base 115 as is described more fully below. As is shown in FIGS. 3A-3B, the sleeve 120 may include a similar engaging portion 122 on a bottom surface of the sleeve 120.

As may be understood by one of ordinary skill in the art, the crimp ring base 115 may include a variety of differently shaped optoelectronic locking tabs 116 and sleeve locking portions 119 without departing from the meaning and scope of the invention. Further, the sleeve 120 may include a variety of differently shaped engaging portions 122 in addition or as an alternative to the resilient tab described and illustrated herein. The examples of locking or engaging features described herein are included merely as examples which may be used in association with the claimed invention. Any other structural arrangements that are effective in providing functionality comparable to that implemented by the above embodiment may alternatively be employed. For example, although the embodiments described herein provide the locking components 119 and 122 in both the upper and lower surfaces of the crimp ring base 115 and the sleeve 120 respectively, these elements may only be included in either the upper or lower surfaces of the respective components.

III. Exemplary Operational Aspects of the Embodiments

FIGS. 3A-3B and 4A-4D are cross-sectional views of the active optic cable 100 of the present invention which illustrate the locking components thereof. As is shown in FIG. 3A, as the proximal end of the active optical cable 100 is inserted into the port of the optoelectronic module 200 in the +y direction or cable insertion direction, the linear movement continues until the MT ferrule 110 engages with a corresponding receiver of the optoelectronic module 200. Once the MT ferrule 110 engages with the receiver of the optoelectronic module 200, and the moving force is continually applied to the sleeve 120, the sleeve 120 is caused to move in the cable insertion direction with respect to the crimp ring base 115.

As the sleeve 120 moves in the cable insertion direction with respect to the crimp ring base 115, the resilient tab of the engaging portions 122 of the sleeve 120 is urged away from the crimp ring base 115 by the resistive force which is generated as the moving force applied to the active optical cable 100 is transferred to the +z direction by the angled portion on an interior surface of the engaging portions 122 sliding along the inclined surface of the sleeve locking portions 119 formed on the upper and lower surfaces of the crimp ring base 115.

Once the sleeve 120 is moved far enough in the cable insertion direction with respect to the crimp ring base 115 so that the engaging portions 122 of the sleeve 120 no longer engage with the sleeve locking portions 119 of the crimp ring base 115 but with the upper and lower surfaces thereof, the assembly is in locked position as is shown in FIG. 3B. As is shown in FIG. 3B, because the sleeve locking portions 119 have the engaging wall described above, when a force is applied in the −y direction or in a cable removal direction, the urging force of the resilient tab in the z direction is not easily overcome and as such, the sleeve 120 is locked into position.

FIGS. 4A-4D illustrate the mechanism for locking the active optical cable 100 to the optoelectronic module 200. More specifically, FIGS. 4A-4D are cross-sectional views of the active optical cable 100 as it engages with the optoelectronic module 200. It is to be noted that the engagement between the optoelectronic locking tabs 116 of the crimp ring base 115 and the arms 250 of the optoelectronic module 200 occurs prior or simultaneously as the engagement between the sleeve locking portion 119 for the crimp ring base 115 and the engaging portion of the sleeve 120.

More particularly, the engagement between the active optical cable 100 and the optoelectronic module 200 occurs as the cable insertion force is applied to the active optical cable 100 in the cable insertion direction. As is shown in FIGS. 4A-4C, as the force is applied, the planar recessed portions 114 of the active optical cable 100 enclose the arms 250 of the optoelectronic module 200 and enable the active optical cable 100 to engagedly slide with respect to the optoelectronic module 200. As is shown in FIGS. 4A-4C, as the cable insertion force continues, the optoelectronic locking tabs 116 engage with the arms 250 of the optoelectronic module 200 and inclined portions of the optoelectronic locking tabs 116 and/or the arms 250 of the optoelectronic module transfer the force in the cable insertion direction into an expansion force in the x direction which causes the arms 250 to be urged away from the optoelectronic locking tabs 116.

At the period shown in FIG. 4D, after the cable insertion force continues, the arms 250 of the optoelectronic module 200 have passed and gone beyond the optoelectronic locking tabs 116 and can no longer back out because the arms 250 are confined inside the sleeve 120. At this time, the sleeve locking portions 119 of the crimp ring base 115 engage with the engaging portions 122 of the sleeve 120 so as to lock the sleeve 120 in place with the sleeve 120 holding the arms 250 in the engaged or locked position within the planar recessed portions 114.

As may be understood, embodiments herein provide a simple and efficient locking mechanism without requiring additional components such as screws or other fixing means. As such, embodiments herein provide an efficient and simple way to reliably connect and attach the active optical cable 100 to the optoelectronic module 200.

As may be understood by one of ordinary skill in the art, the present invention may be embodied in other specific forms. In another embodiment of the invention, the locking features may be disposed on the ferrule boot 112 and the crimp ring 170 with a compressive spring 155 being disposed there between.

The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A pluggable active optical cable connector configured to permanently maintain engagement of an optical interface included in an optoelectronic module, the pluggable active optical cable connector comprising:
a lens connection section which connects a plurality of optic fibers to the optical interface;
a latching portion which engages with a latch receiving portion of the optoelectronic module, the latching portion causing the optic fibers of the lens connection section to maintain engagement with the optical interface, the latching portion including a first engagement portion which engages with an optoelectronic engagement portion of the optical interface and a second engagement portion; and
a locking portion which engages with the second engagement portion of the latching portion and locks the lens connection section in place with respect to the optoelectronic module as a plug insertion force is applied to the pluggable active optical cable connector so as to prevent the lens connection section from disengaging from the optical interface of the optoelectronic module.

2. The pluggable active optical cable connector of claim 1, wherein the latching portion is formed as an integral component of a crimp ring base which houses an MT ferrule.

3. The pluggable active optical cable connector of claim 2, wherein the locking portion is formed as an integral component of a sleeve which is formed so as to enclose at least a portion of the latching portion.

4. The pluggable active optical cable connector of claim 3, wherein the second engaging portion of the latching portion comprises an engaging tooth formed in at least one of an upper and lower surface of the latching portion, and wherein the locking portion comprises a resilient tab formed in at least one of an upper and lower surface of the sleeve.

5. The pluggable active optical cable connector of claim 1, wherein the second engaging portion of the latching portion comprises an engaging tooth formed in at least one of an upper and lower surface of the latching portion, and wherein the locking portion comprises a resilient tab formed in at least one of an upper and lower surface of the sleeve.

6. The pluggable active optical cable connector of claim 1, wherein the locking portion also engages with the optoelectronic engagement portion.

7. The pluggable active optical cable connector of claim 6, wherein the first engagement portion comprises a recess and the optoelectronic engagement portion comprises an arm which is disposed within the recess when the pluggable active optical cable is in a locked position, and wherein the locking portion provides an urging force which causes the arm to be securely fixed in the recess.

8. The pluggable active optical cable connector of claim 2, wherein the locking portion is formed as an integral component of a sleeve which is formed so as to enclose at least a portion of the latching portion and the optoelectronic engagement portion.

9. The pluggable active optical cable connector of claim 8, wherein the first engagement portion comprises a recess and the optoelectronic engagement portion comprises an arm which is disposed within the recess when the pluggable active optical cable is in a locked position, and wherein the compressive force provided as the sleeve encloses the arm provides an urging force which causes the arm to be securely fixed in the recess.

10. An integrated active optical cable and optoelectronic module comprising:
an optical interface which interfaces with a port of a host device;
a lens connection section which connects a plurality of optic fibers to the optical interface;
a latching portion which engages with a latch receiving portion of the optical interface, the latching portion causing the optic fibers of the lens connection section to maintain engagement with the lens assembly of the optical interface, the latching portion including a first engagement portion which engages with an optoelectronic engagement portion of the optical interface and a second engagement portion; and
a locking portion which engages with the second engagement portion of the latching portion and lock the lens connection section in place with respect to the optical interface as a plug insertion force is applied to the pluggable active optical cable connector so as to prevent the lens connection section from disengaging from the optical interface.

11. The integrated active optical cable and optoelectronic module of claim 10, wherein the latching portion is formed as an integral component of a crimp ring base which houses an MT ferrule.

12. The integrated active optical cable and optoelectronic module of claim 11, wherein the locking portion is formed as an integral component of a sleeve which is formed so as to enclose at least a portion of the latching portion.

13. The integrated active optical cable and optoelectronic module of claim 12, wherein the second engaging portion of the latching portion comprises an engaging tooth formed in at least one of an upper and lower surface of the latching portion, and wherein the locking portion comprises a resilient tab formed in at least one of an upper and lower surface of the sleeve.

14. The integrated active optical cable and optoelectronic module of claim 10, wherein the second engaging portion of the latching portion comprises an engaging tooth formed in at least one of an upper and lower surface of the latching portion, and wherein the locking portion comprises a resilient tab formed in at least one of an upper and lower surface of the sleeve.

15. The integrated active optical cable and optoelectronic module of claim 11, wherein the locking portion also engages with the optoelectronic engagement portion.

16. The integrated active optical cable and optoelectronic module of claim 15, wherein the first engagement portion comprises a recess and the optoelectronic engagement portion comprises an arm which is disposed within the recess when the pluggable active optical cable is in a locked position, and wherein the locking portion provides an urging force which causes the arm to be securely fixed in the recess.

17. The integrated active optical cable and optoelectronic module of claim 12, wherein the locking portion is formed as an integral component of a sleeve which is formed so as to enclose at least a portion of the latching portion and the optoelectronic engagement portion.

18. The integrated active optical cable and optoelectronic module of claim 17, wherein the first engagement portion comprises a recess and the optoelectronic engagement portion comprises an arm which is disposed within the recess when the pluggable active optical cable is in a locked position, and wherein the compressive force provided as the sleeve encloses the arm provides an urging force which causes the arm to be securely fixed in the recess.

19. An optoelectronic system comprising the pluggable active optical cable connector of claim 1.

20. An optoelectronic system comprising the integrated active optical cable and optoelectronic module of claim 10.
